(19) United States
(12) Patent Application Publication
(10) Pub. No.: US 2001/0032124 A1
(43) Pub. Date: Oct. 18, 2001

(54) Software, apparatus, and method for hand-held electronic devices and advertising thereon

(76) Inventors: James A. Savage, Mt. Pleasant, SC (US); Paul A. Joyce, Akron, OH (US)

Correspondence Address: Daniel A. Thomson, One Cascade Plaza, Fourteenth Floor, Akron, OH, 44333-1343, US

(21) Appl. No.: 09/736,032

(22) Filed: Dec. 13, 2000

Related U.S. Application Data
(60) Provisional application No. 60/177,914, filed on Jan. 25, 2000.

(51) Int. Cl. G06F 17/60

(52) U.S. Cl. 705/14; 705/2

(57) ABSTRACT

A new and improved method and apparatus for writing electronic prescriptions is described herein. The system includes placing advertising on the electronic device, such that the advertising is viewable on the hand-held electronic device's viewing screen, the advertising being selectively updatable.

This application claims priority from U.S. Provisional Patent application, Ser. No. 60/177,914, entitled SOFTWARE, APPARATUS, AND METHOD FOR ELECTRONIC WRITING OF MEDICAL PRESCRIPTIONS AND OTHER REPETITIVE DOCUMENTS TYPICALLY WRITTEN ON PRE-PRINTED PAPER FORMS, filed on Jan. 25, 2000.

### I. BACKGROUND OF THE INVENTION

A. Field of the Invention

This invention relates to the art of hand-held electronic devices, and more particularly to hand-held electronic devices used in the medical field, and even more particularly to placing advertisements on the hand-held electronic devices.

B. Description of the Related Art

Currently, physicians, and other individuals in the health care profession, are using hand-held electronic devices to write prescriptions. This alleviates the concern that has grown in the past years over illegible writing and signatures on prescription forms, which has led to overdoses, wrong prescriptions, and a variety of other problems. The electronic prescription is a safe, quick, and efficient method of prescribing medication.

The present invention provides a new and improved apparatus and method for electronically writing prescriptions and implementing advertising on hand-held electronic devices, and overcomes certain difficulties inherent in the related inventions while providing better overall results.

### II. SUMMARY OF THE INVENTION

In accordance with one aspect of the present invention, a hand-held electronic device includes a central processing unit, random accessible memory, a viewing screen, a mother board, a modem, and data entry means, prescription writing means, at least one advertisement, the at least one advertisement being viewable on the viewing screen, the at least one advertisement being chosen from the group comprising color highlighting of associated product, color background graphics identifying the product, video, animation, splash screen displayed in between a prescribing session, audio, audio visual, printable discount coupons, and printable company logo, and updating means for updating the at least one advertisement.

In accordance with another aspect of the present invention, a method for providing advertising includes the steps of providing a hand-held electronic device having a central processing unit, random accessible memory, a mother board, a viewing screen, and data entry means, providing software for operating the device, and providing means for advertising, the advertising being viewable on the viewing screen, the advertising being stored on the device.

In accordance with yet another aspect of the present invention, the method includes the step of providing means for updating the advertising.

In accordance with another aspect of the present invention, the method includes the steps of updating the advertising via the modem and printing a prescription with the advertising on the prescription.

In accordance with still another aspect of the present invention a hand-held electronic device includes a central processing unit, random accessible memory, a mother board, a viewing screen, a modem, data entry means, at least one advertisement, the at least one advertisement being viewable on the viewing screen, the at least one advertisement being permanently stored on the device, printing means for printing prescriptions, and updating means for updating the at least one advertisement.

In accordance with another aspect of the present invention a computer readable medium containing instructions for controlling a computer system to perform a method, the method including the steps of providing at least one electronic banner advertisement for an electronic hand-held device, the at least one advertisement being permanently stored on the electronic hand-held device, the device having a central processing unit, random accessible memory, a mother board, a modem, and data entry means, updating the at least one advertisement, wherein the at least one advertisement is chosen from the group comprising color highlighting of associated product, color background graphics identifying the product, splash screen displayed in between a prescribing session, audio, audio visual, printable discount coupons, and printable company logo.

Still other benefits and advantages of the invention will become apparent to those skilled in the art upon a reading and understanding of the following detailed specification.

### III. DEFINITIONS

Advertising—A payment by a company for the promotion of its identity, products or services, or a combination of any or all of the three. This promotion may be accomplished through four categories—1) electronic display; 2) audio; 3) video; and 4) a hard copy printed on the front and/or reverse side, or any combination of the four categories. Also, information collected from the use of either form of advertising, i.e. the prescribing habits of the advertising reader (health care professional) would be derived from and therefore be a form of advertising.

Modem—a device that converts signals produced by one type of device (as a computer) to a form compatible with another (as a telephone)

### IV. DESCRIPTION OF THE PREFERRED EMBODIMENT

This embodiment of the invention is directed to prescription writers, but can be used on any portable electronic device. Some examples of devices that may use this invention are as follows: hand-held, platform independent, platform dependent, pen-based, voice recognition, voice interactive computer, or digital assistants. However, this list is not intended to limit the invention in any way, but is only intended to show a representative sample of the type of electronic device that may incorporate the following invention. Also included within the definition of hand-held devices is cellular phones with the capability of a hand-held computer.

The hand-held device has wireless communication ability, printing capability, either via direct connection to a printer, wireless connection to a printer, or having printing means within the device itself, a modem (or some other signal converter), a central processing unit, random accessible memory, a motherboard, a viewing screen, and means for entering data into the device. The modem is set up for remote updating of the drug database and advertising features.

Advertising is added to the device, wherein the advertising can be seen on the viewing screen of the hand-held device. In this embodiment of the invention, the advertising will mostly be for drug companies, but the invention is not limited to drug advertising. The advertising can be added to the software of the device before the device is constructed. For example, the drug companies might manufacture their own devices, or have an agreement with the device manufacturer, wherein the drug company's advertisements are on the device when the device is shipped to a consumer.

In the alternative, the advertising may be added after the device is constructed. For example, the advertising can be added to the device upon request of the drug company. This advertising can be any mean as along as chosen using sound engineering judgment.

In this particular embodiment, the advertising would be sold to pharmaceutical companies to advertise their drugs and other health care products, so that when the physician is using the hand-held device, or writing a prescription on the hand-held device, the pharmaceutical company's advertising appears on the screen. The advertising is permanently stored on the hand-held device, preferably as part of the software code. By permanently stored, it is meant that the advertising is not saved in a temporary file or directory. The advertising space can be sold and implemented by either the manufacturer of the device or the health care professional. The advertising can be in the form of a splash screen, wherein the color of the screen changes according to the prescription that is being written. Therefore, the pharmaceutical company's color is associated with the particular prescription that is being written. For example, if a particular company uses certain colors in their logo or trademark, those colors can be viewed on the viewing screen, or if a particular pill always comes in a particular color, this color may be used on the screen. The splash screen can be used alone, or in combination with any other advertising scheme chosen using sound engineering and business judgment.

The advertising can be either visual or auditory. The advertising can be in the form of the company's logo, brand name, color, or any other means of identifying the company as a source. The advertising can also take the form of any type of audio message, including the company's name or jingle. The advertising, in any of the visual or auditory forms can include educational and seminar information and updates. The hand-held device can be set up to periodically deliver the information or updates.

Another form that the advertising may take is when the prescription is printed from the hand-held device or when the prescription is transferred to another device. When the prescription is printed, the company's advertising can be printed directly onto the prescription. The advertising could also comprise printing a coupon attachment to the prescription. The advertising may be printed on the front and/or back of the coupon.

Another embodiment of the advertising would encompass a sales representative sending a physician, or other customer, an advertisement regarding their product. The doctor can then view or print the advertisement at his leisure.

Also, if the prescription is sent electronically to a second device, the inventive system can attach the advertising to that transmission, so that when the receiving party receives the prescription or other transmission, the advertisement is located on the receiving device, so that the receiver can view it.

The advertising can either be static or active (i.e. the advertising scrolls across the screen, is simply in the background behind any text or prescription, or is static text on a portion of the screen). The advertising may be designed to adjust according to physician preference or according to a particular illness that is entered. The advertising may be customized in any manner as long as chosen using sound engineering and business judgment. The advertising may also be periodically updated on the device, via modem or any other method capable of updating the information. The advertising will be part of a software code, and the updating will update the software code.

As stated before, this invention is not limited to the particular hand-held device described in this embodiment, nor is it limited to prescription writers or the health care industry. The inventive process can be used with any portable or hand-held electronic device on which advertising would be suitable or desired. The design and operation of the hand-held devices is well known in the art, and, for the sake of brevity, will not be described herein. The operation and implementation of the advertising on the handheld device would be well within the capabilities of one of ordinary skill in the art, and therefore will not be further described herein.

Electronic display advertising could be done by any means used to distinguish a company from competitors or competitors' products/services. This may be done by, but is not limited to, distinctions and variations to text, audio announcements, products, product labels, illustrations, full color pictures and animations, and summary lists generated from the use of such advertising. The customer may also opt to have their company represented in printed form. This may take the form of, but is not limited to, all of the above electronic variations, but rendered in a printed format on a substrate such as paper.

The invention has been described with reference to one embodiment. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A hand-held electronic device comprising:
a central processing unit;
random accessible memory;
a viewing screen;
a motherboard;
a modem;
data entry means;
prescription writing means;
at least one advertisement, the at least one advertisement being viewable on the viewing screen, the at least one advertisement being permanently stored on the device, the at least one advertisement being chosen from the group comprising color highlighting of associated product, color background graphics identifying the product, video, animation, splash screen displayed in between a prescribing session, audio, audio visual, printable discount coupons, and printable company logo; and,
updating means for updating the at least one advertisement.

2. A method for providing advertising, the method comprising the steps of:
providing a hand-held electronic device having a central processing unit, random accessible memory, a mother board, a viewing screen, and data entry means;
providing software for operating the device; and,
providing means for advertising, the advertising being viewable on the viewing screen, the advertising being permanently stored on the device.

3. The method of claim 2, wherein the method further comprises the step of:
updating the advertising via updating the software.

4. The method of claim 3, wherein providing a hand-held electronic device having a central processing unit, random accessible memory, a mother board, a viewing screen, and data entry means comprises the step of:
providing a hand-held electronic device having a central processing unit, random accessible memory, a motherboard, a viewing screen, a signal converter, and data entry means.

5. The method of claim 4, wherein providing means for advertising, the advertising being viewable on the viewing screen, the advertising being permanently stored on the device comprises the step of:
providing means for advertising, the advertising being viewable on the viewing screen, the advertising being permanently stored on the device, the advertising being chosen from one or more of the group comprising color highlighting of associated product, color background graphics identifying the product, video, animation, splash screen displayed in between a prescribing session, audio, audio visual, printable discount coupons, and printable company logo.

6. The method of claim 4, wherein the method further comprises the step of:
updating the advertising via the signal converter.

7. The method of claim 4, wherein the method further comprises the step of:
printing a prescription with the advertising on the prescription.

8. A hand-held electronic device having a central processing unit, random accessible memory, a mother board, a viewing screen, data entry means, the device comprising:
at least one advertisement, the at least one advertisement being viewable on the viewing screen, the at least one advertisement being permanently stored on the device.

9. The device of claim 8, wherein the device further comprises:
a signal converter; and, printing means.

10. The device of claim 9, wherein the device further comprises updating means for updating the at least one advertisement.

11. The device of claim 10, wherein the at least one advertisement is chosen from one or more of the group comprising color highlighting of associated product, color background graphics identifying the product, video, animation, splash screen displayed in between a prescribing session, audio, audio visual, printable discount coupons, and printable company logo.

12. A method for advertising, the method comprising the steps of:
providing a hand-held electronic device; and,
providing at least one electronic banner advertisement on the device, the advertisement being permanently stored on the device.

13. The method of claim 12, wherein the method further comprises the steps of:
transmitting prescription information; and,
printing prescriptions.

14. The method of claim 13, wherein the method further comprises the step of:
printing the at least one advertisement on the prescription.

15. The method of claim 12, wherein providing at least one electronic banner advertisement on the device, the advertisement being permanently stored on the device comprises the step of:
providing at least one electronic banner advertisement on the device, the advertisement being permanently stored on the device, the at least one advertisement is chosen from one or more of the group comprising color highlighting of associated product, color background graphics identifying the product, video, animation, splash screen displayed in between a prescribing session, audio, audio visual, printable discount coupons, and printable company logo.

16. A computer readable medium containing instructions for controlling a computer system to perform a method, the method comprising:
providing at least one electronic banner advertisement for an electronic handheld device, the at least one advertisement being permanently stored on the electronic hand-held device.

17. The computer readable medium of claim 16, wherein the method comprises:
updating the at least one advertisement.

18. The computer readable medium of claim 17, wherein providing at least one electronic banner advertisement for an electronic hand-held device, the at least one advertisement being permanently stored on the electronic hand-held device, comprises:
providing at least one electronic banner advertisement for an electronic handheld device, the at least one advertisement being permanently stored on the electronic hand-held device, the device having a central processing unit, random accessible memory, a mother board, a signal converter, and data entry means.

19. The computer readable medium of claim 18, wherein the at least one advertisement is chosen from the group comprising color highlighting of associated product, color background graphics identifying the product, video, animation, splash screen displayed in between a prescribing session, audio, audio visual, printable discount coupons, and printable company logo.
